(19) United States
(12) Patent Application Publication
(10) Pub. No.: US 2016/0378305 A1
(43) Pub. Date: Dec. 29, 2016

(54) INFORMATION PROCESSING SYSTEM, OPERATION TARGET APPARATUS, AND COMPUTER-READABLE RECORDING MEDIUM

(71) Applicant: Tomoki SHIBUKAWA, Tokyo (JP)

(72) Inventor: Tomoki SHIBUKAWA, Tokyo (JP)

(73) Assignee: Ricoh Company, Ltd., Tokyo (JP)

(21) Appl. No.: 15/185,201

(22) Filed: Jun. 17, 2016

(30) Foreign Application Priority Data
Jun. 24, 2015 (JP) 2015-126704

(51) Int. Cl. G06F 3/0484; G06F 17/28

(52) U.S. Cl. CPC G06F 3/04842; G06F 17/289

(57) ABSTRACT

A first communication controller performs control of transmitting, to an operation target apparatus, first language setting information including language information of a first language setting indicating a language setting for a screen display in a first display unit. A second communication controller performs control of receiving the first language setting information transmitted by the operation device. A determining unit determines whether the language information of the first language setting specified by the received first language setting information is included in settable language information indicating information of a language that is settable in a screen display in a second display unit. A setting unit sets, when the language information of the first language setting is determined to be included in the settable language information, language of a second language setting indicating a language setting for the screen display in the second display unit as language of the first language setting.

### CROSS-REFERENCE TO RELATED APPLICATION

The present application claims priority under 35 U.S.C. §119 to Japanese Patent Application No. 2015-126704, filed Jun. 24, 2015. The contents of which are incorporated herein by reference in their entirety.

### BACKGROUND OF THE INVENTION

1. Field of the Invention

The present invention relates to an information processing system, an operation target apparatus, and a computer-readable recording medium.

2. Description of the Related Art

Conventionally, a technique capable of outputting instructions and information of various kinds from a device connected to an image forming apparatus to the image forming apparatus has been known. An information device such as a PC (Personal Computer), a dedicated device that outputs instructions of various kinds to the image forming apparatus, a smartphone and a tablet terminal carried by a user, and the like are taken as an example of the device connected to the image forming apparatus. In the technique, there is a request for standardizing the language used in the device and the language to be displayed in a display unit of the image forming apparatus to improve a convenience of a user.

Japanese Patent Application Laid-Open No. 2007-166516 discloses a technique of obtaining font information in a digital camera connected to an image forming apparatus and realizing a display in which the language is converted to the language corresponding to the obtained font information by an operation panel of the image forming apparatus. Japanese Patent Application Laid-Open No. 2007-166516 also discloses a technique of switching the language to be displayed in the operation panel of the image forming apparatus in response to a switching of the language displayed at the side of the digital camera when the digital camera is connected to the image forming apparatus. Other related techniques are disclosed in Japanese Patent Application Laid-Open No. 2008-193265 and Japanese Patent Application Laid-Open No. 2014-176023.

However, the conventional technique is not intended to control, when the image forming apparatus and the device capable of operating the image forming apparatus independently include respective display units, the settings of languages to be displayed in both of the display units. As a result, when the image forming apparatus and the device capable of operating the image forming apparatus independently include respective display units, there is a problem, in the conventional technique, of having a difficulty in controlling the settings of the languages to be displayed in both of the display units due to a lack of measure for coordination between the image forming apparatus and the device.

### SUMMARY OF THE INVENTION

According to one aspect of the present invention, an information processing system includes an operation device; and an operation target apparatus to be operated by the operation device. The operation device includes a first display controller configured to control a screen display in a first display unit; and a first communication controller configured to perform control of transmitting first language setting information to the operation target apparatus. The first language setting information includes language information of a first language setting indicating a language setting for the screen display in the first display unit. The operation target apparatus includes a second display controller configured to control a screen display in a second display unit; a second communication controller configured to perform control of receiving the first language setting information transmitted by the operation device; a determining unit configured to determine whether the language information of the first language setting specified by the received first language setting information is included in settable language information indicating information of a language that is settable in the screen display in the second display unit; and a setting unit configured to set, when the determining unit determines that the language information of the first language setting is included in the settable language information, a language of a second language setting indicating a language setting for the screen display in the second display unit, as a language of the first language setting.

### BRIEF DESCRIPTION OF THE DRAWINGS

FIG. 1 illustrates an example of a configuration of an information processing system according to a first embodiment;

FIG. 2 is a block diagram of an example of a hardware configuration of an operation device and an image forming apparatus according to the first embodiment;

FIG. 3 is a block diagram of another example of a hardware configuration of the operation device and the image forming apparatus according to the first embodiment;

FIG. 4 is a block diagram of still another example of a hardware configuration of the operation device and the operation target apparatus according to the first embodiment;

FIG. 5 is a block diagram of an example of a functional configuration of the operation device and the image forming apparatus according to the first embodiment;

FIG. 6 illustrates an example of a screen to be displayed in a first display unit of the operation device according to the first embodiment;

FIG. 7 illustrates an example of a selection screen that allows selecting an alternative language according to the first embodiment;

FIG. 8 is a sequence diagram of an example of a flow of a language setting processing according to the first embodiment;

FIG. 9 is a block diagram of an example of a functional configuration of an operation device and an image forming apparatus according to a second embodiment;

FIG. 10 is a sequence diagram of an example of a flow of a language setting processing according to the second embodiment; and

FIG. 11 is a sequence diagram of an example of a flow of a language setting processing when a wireless connection is disconnected according to the second embodiment.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of an embodiment is to provide an information processing system capable of controlling, when an operation device and an operation target apparatus as an operation target of the operation device independently include respective display units, the settings of languages to be displayed in both of the display units.

Exemplary embodiments of an information processing system, an operation target apparatus, and an information processing program according to the present invention will be explained below with reference to the accompanying drawings. It should be noted that the present invention is not limited to the embodiments below. It should also be noted that the embodiments may be appropriately combined within a scope with consistency in content.

### First Embodiment

### System Configuration According to First Embodiment

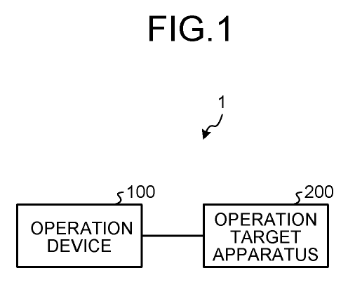

A configuration of an information processing system according to a first embodiment will be explained with reference FIG. 1. FIG. 1 illustrates an example of a configuration of an information processing system according to the first embodiment.

As illustrated in FIG. 1, an information processing system 1 is provided with an operation device 100 and an operation target apparatus 200. For connection between the operation device 100 and the operation target apparatus 200, there is an interface for a wired connection such as a USB (Universal Serial Bus) and for a wireless connection such as a wireless LAN (Local Area Network). The interface may be USB, serial, wired/wireless LAN, Bluetooth®, IrDA (Infrared Data Association), and Wi-Fi (Wireless Fidelity) regardless of standards.

For example, the operation device 100, which receives inputs depending on operations by a user, may be a dedicated device that allows operating the operation target apparatus 200 and may be a smartphone or a tablet terminal carried by a user. In the case where the operation device 100 is a smartphone or a tablet terminal, the operation device 100 and the operation target apparatus 200 operate independently of each other by separated OSs (Operating Systems). The operation target apparatus 200 may be any device which can be operated by the operation device 100. For example, the operation target apparatus 200 may be an image forming apparatus such as an MFP (Multi-Function Peripheral) capable of realizing at least two functions among a copying function, a scanner function, a facsimile function, a printer function, and the like as will be explained later.

In the configuration explained above, the operation device 100, which includes a first display unit that displays a screen, transmits first language setting information including language information of a first language setting that indicates a language setting for a screen display in the first display unit to the operation target apparatus 200.

The operation target apparatus 200, which includes a second display unit that displays a screen, determines when receiving the first language setting information transmitted by the operation device 100, whether or not the language information of the first language setting specified by the received first language setting information is included in settable language information that indicates information of a settable language in the screen display in the second display unit. When determining that the language information of the first language setting is included in the settable language information, the operation target apparatus 200 sets a language of the first language setting as a language of a second language setting that indicates a language setting for a screen display in the second display unit.

In other words, the operation device 100 transmits the language information of the language setting for the screen display in the first display unit to the operation target apparatus 200 in the information processing system 1. When the language information received from the operation device 100 is included in the settable language information that is settable in the screen display in the second display unit, the operation target apparatus 200 switches the language of the language setting for the screen display in the second display unit to the language of the language information received from the operation device 100 in the information processing system 1. As a result, it is possible in the information processing system 1 to control the settings of languages to be displayed in both of the display units of the operation device 100 and the operation target apparatus 200 in conjunction with each other.

Hardware Configuration of Each Device According to First Embodiment

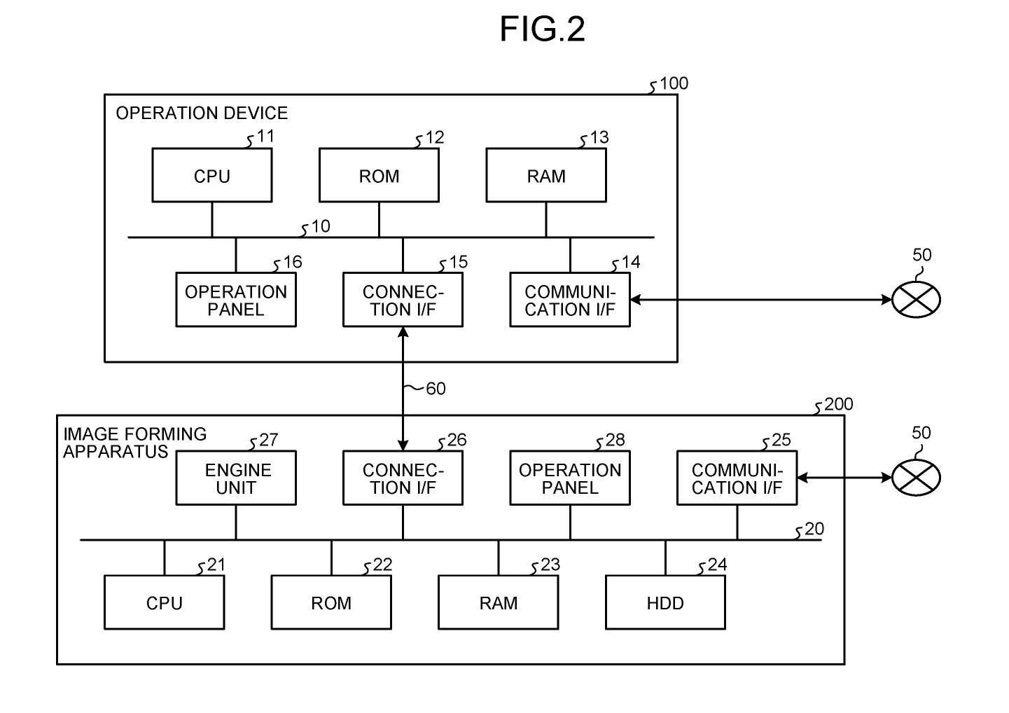

Next, a hardware configuration of each device according to the first embodiment will be explained with reference to FIGS. 2 to 4. As explained above, the operation target apparatus 200 may be an image forming apparatus, for example. In the explanation below, an image forming apparatus 200 may be taken as an example of the operation target apparatus.

FIG. 2 is a block diagram of an example of a hardware configuration of the operation device 100 and the image forming apparatus 200 according to the first embodiment.

As illustrated in FIG. 2, the operation device 100 is provided with a CPU (Central Processing Unit) 11, a ROM (Read Only Memory) 12, a RAM (Random Access Memory) 13, a communication I/F 14, a connection I/F 15, and an operation panel 16. Those units are mutually connected via a system bus 10.

The CPU 11 controls the operation of the operation device 100 as a whole. The CPU 11 uses the RAM 13 as a work area and executes programs stored in the ROM 12 and the like to control the entire operation of the operation device 100. The CPU 11 thereby realizes functions of various kinds depending on inputs received depending on operations by a user. The communication I/F 14 is an interface for wireless connection and for connection to a network 50. For example, the network 50 is a wireless LAN and the like. The connection I/F 15 is an interface for wired connection and for communication with the image forming apparatus 200 via a communication path 60. For example, a USB standard path can be used for the communication path 60. The operation panel 16 includes a touch sensitive screen, a keyset, and the like. For example, a touch sensitive screen is an LCD (Liquid Crystal Display) device equipped with a touch sensitive panel function and an organic EL (Electro Luminescence) display device. A keyset is a set of hardware keys.

As illustrated in FIG. 2, the image forming apparatus 200 as the operation target apparatus is provided with a CPU 21, a ROM 22, a RAM 23, an HDD (Hard Disk Drive) 24, a communication I/F 25, a connection I/F 26, an engine unit 27, and an operation panel 28. Those units are mutually connected via a system bus 20.

The CPU 21 controls the operation of the image forming apparatus 200 as a whole. The CPU 21 uses the RAM 23 as a work area and executes programs stored in the ROM 22 or the HDD 24 to control the entire operation of the image forming apparatus 200 and realize functions of various kinds including the copying function, the scanner function, the facsimile function, and the printer function and various kinds of functions to be explained later. The communication I/F 25 is an interface for wireless connection and for connection to a network 50. The connection I/F 26 is an interface for wired connection and for communication with the operation device 100 via the communication path 60. The engine unit 27 is an image forming engine and the like, and is a black-and-white plotter, a drum color plotter, a scanner, or a facsimile unit, for example. The operation panel 28 includes a touch sensitive screen, a keyset, and the like. The operation panel 28 may be a display device that simply displays a screen.

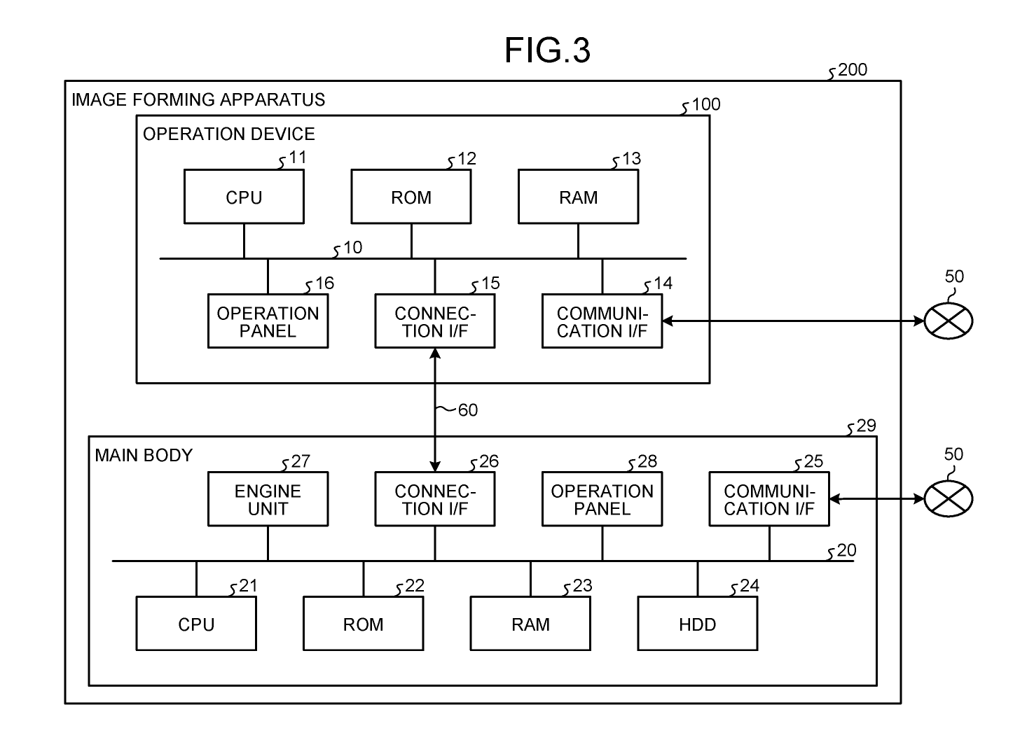

In the embodiment, the operation device 100 may be detachable from the image forming apparatus 200 as the operation target apparatus. A hardware configuration in this case is illustrated in FIG. 3. FIG. 3 is a block diagram of another example of a hardware configuration of the operation device 100 and the image forming apparatus 200 according to the first embodiment. As illustrated in FIG. 3, the image forming apparatus 200 is provided with the operation device 100 and a main body 29. The main body 29 in this configuration corresponds to the image forming apparatus 200 illustrated in FIG. 2. Explanation of each hardware unit is the same as the explanation made with reference to FIG. 2.

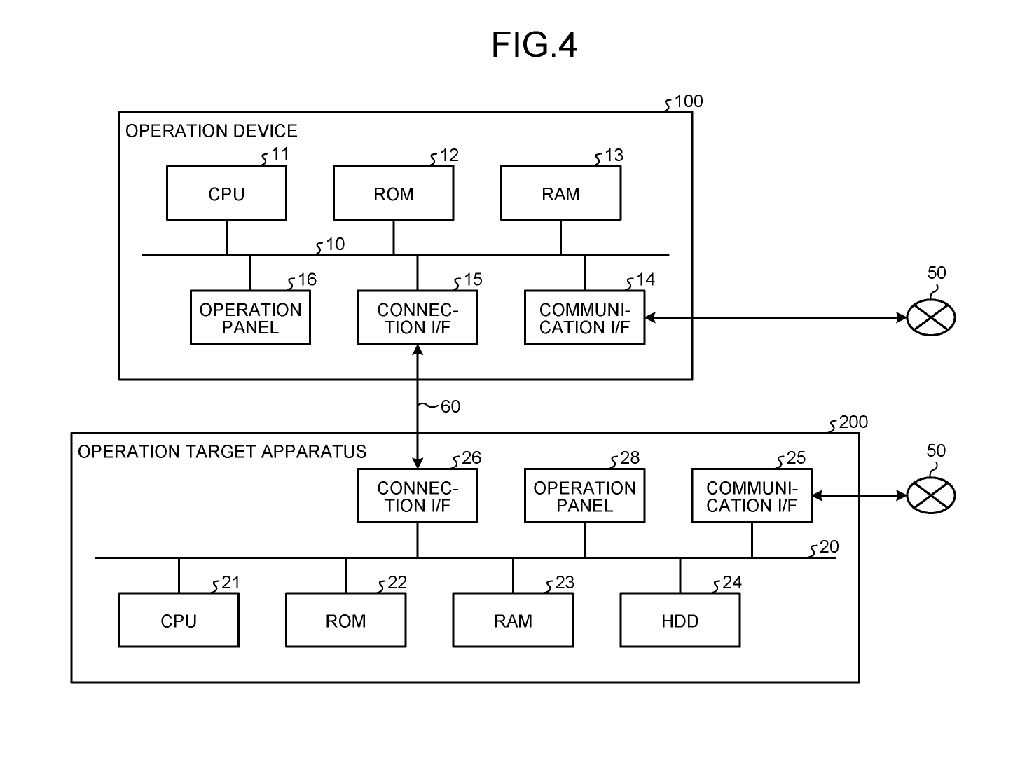

FIG. 4 is a block diagram of still another example of a hardware configuration of the operation device 100 and the operation target apparatus 200 according to the first embodiment. The image forming apparatus 200 in this configuration is provided with the CPU 21, the ROM 22, the RAM 23, the HDD 24, the communication I/F 25, the connection I/F 26, and the operation panel 28 and differs in hardware from the image forming apparatus 200 illustrated in FIG. 2 in that the engine unit 27 is not provided.

The CPU 21 controls the operation of the operation target apparatus 200 as a whole. The CPU 21 uses the RAM 23 as a work area and executes programs stored in the ROM 22 or the HDD 24 to control the entire operation of the operation target apparatus 200 and realize various kinds of functions to be explained later. The communication I/F 25 is an interface for wireless connection and for connection to the network 50. The connection I/F 26 is an interface for wired connection and for communication with the operation device 100 via the communication path 60. The operation panel 28 includes a touch sensitive screen, a keyset, and the like. The operation panel 28 may be a display device that simply displays a screen.

Functional Configuration of Each Device According to First Embodiment

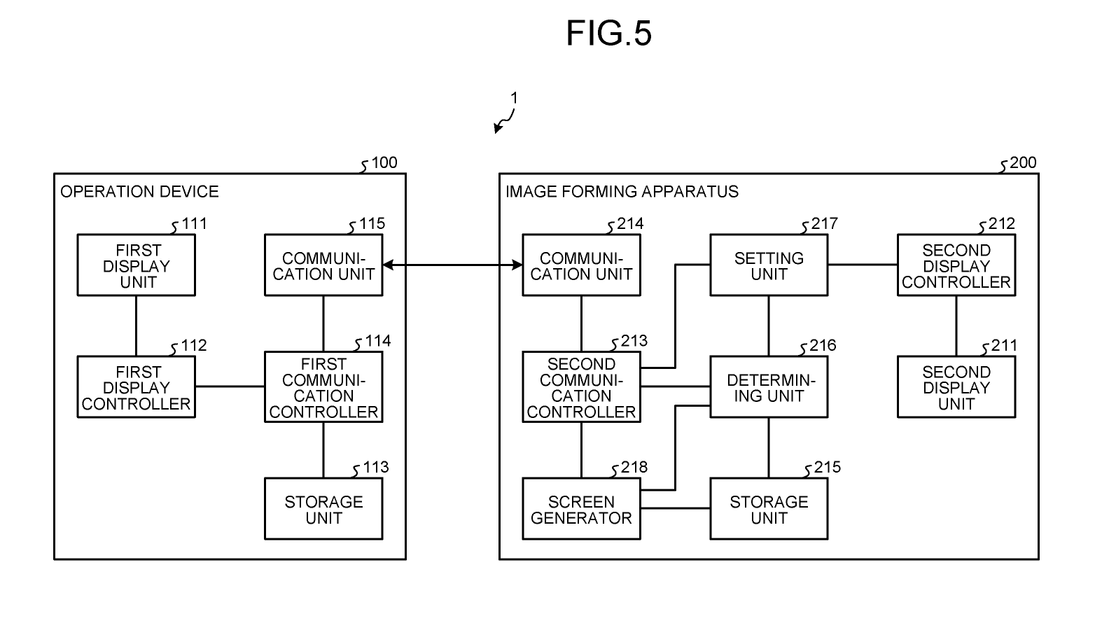

A functional configuration of each device according to the first embodiment will be explained with reference to FIG. 5 next. FIG. 5 is a block diagram of an example of a functional configuration of the operation device 100 and the image forming apparatus 200 according to the first embodiment. The functional configuration of the operation target apparatus 200 is the same as the functional configuration of the image forming apparatus 200 to be explained below.

As illustrated in FIG. 5, the operation device 100 is provided with a first display unit 111, a first display controller 112, a storage unit 113, a first communication controller 114, and a communication unit 115. A part or all of the first display controller 112 and the first communication controller 114 may be realized by software (program) or may be realized by hardware circuit. The first display controller 112 and the first communication controller 114 correspond to functions of the programs to be executed by the CPU 11.

The first display unit 111 displays information of various kinds (screen) in accordance with the control by the first display controller 112. The first display unit 111 corresponds to the operation panel 16. The first display controller 112 controls a screen display in the first display unit 111 and receives inputs of information of various kinds depending on operations by a user. For example, the first display controller 112 receives a request for switching the language of the first language setting indicating a language setting for the screen display in the first display unit 111 depending on an operation by a user. The first display controller 112 controls the first display unit 111 to display a selection screen which will be explained later and receives a selection depending on an operation by a user.

The storage unit 113 stores information of various kinds. The storage unit 113 corresponds to the ROM 12, the RAM 13, or the like. For example, the storage unit 113 stores information of a language which is settable so that the screen is displayed with the settable language in the screen display in the first display unit 111.

The first communication controller 114 performs a control of transmitting and receiving information of various kinds with the image forming apparatus 200 and the like via the communication unit 115. The communication unit 115 corresponds to the communication I/F 14 or the connection I/F 15. In the embodiment, a case where the communication unit 115 corresponds to the connection I/F 15 will be taken as an example. For example, the first communication controller 114 performs a control of transmitting, to the image forming apparatus 200 as the operation target apparatus, the first language setting information including the language information of the first language setting that indicates the language setting for the screen display in the first display unit 111 via the communication unit 115. As one mode, a trigger for transmitting first language setting information is when a request for switching the language of the first language setting is received. In other words, when the request for switching the language, to be displayed in the first display unit 111, of the first language setting is received by the first display controller 112, the first communication controller 114 transmits the first language setting information including the received language information of the first language setting to the image forming apparatus 200 via the communication unit 115.

Besides, the first communication controller 114 receives format information of a selection screen from the image forming apparatus 200 via the communication unit 115 and outputs the received format information of the selection screen to the first display controller 112, for example. The first communication controller 114 then transmits, to the image forming apparatus 200 via the communication unit 115, selected language information which is a result of the selection received by the first display controller 112 depending on the display of the selection screen.

As illustrated in FIG. 5, the image forming apparatus 200 is provided with a second display unit 211, a second display controller 212, a second communication controller 213, a communication unit 214, a storage unit 215, a determining unit 216, a setting unit 217, and a screen generator 218. A part or all of the second display controller 212, the second communication controller 213, the determining unit 216, the setting unit 217, and the screen generator 218 may be realized by software (program) or may be realized by hardware circuit. The second display controller 212, the second communication controller 213, the determining unit 216, the setting unit 217, and the screen generator 218 correspond to functions of the programs to be executed by the CPU 21.

The second display unit 211 displays information of various kinds (screen) in accordance with the control by the second display controller 212. The second display unit 211 corresponds to the operation panel 28. The second display controller 212 controls a screen display in the second display unit 211 and receives inputs of information of various kinds depending on operations by a user. For example, the second display controller 212 controls the screen display in the second display unit 211 so that the screen is displayed with the set language depending on the language setting by the setting unit 217.

The second communication controller 213 performs a control of transmitting and receiving information of various kinds with the operation device 100 and the like via the communication unit 214. The communication unit 214 corresponds to the communication I/F 25 or the connection I/F 26. In the embodiment, a case where the communication unit 214 corresponds to the connection I/F 26 will be taken as an example. For example, the second communication controller 213 receives the first language setting information transmitted by the operation device 100 in response to the request for switching the language of the first language setting via the communication unit 214.

Besides, the second communication controller 213 performs a control of transmitting, to the operation device 100 via the communication unit 214, format information of the selection screen generated by the screen generator 218. The second communication controller 213 then performs a control of receiving selected language information returned by the operation device 100 in response to the transmission of the format information of the selection screen via the communication unit 214.

The storage unit 215 stores information of various kinds. The storage unit 215 corresponds to the ROM 22, the RAM 23, the HDD 24, or the like. For example, the storage unit 215 stores settable language information that indicates information of a language which is settable so that the screen is displayed with the settable language in the screen display in the second display unit 211. Here, the settable language information may be stored not in the storage unit 215 but in an external storage device.

The determining unit 216 determines whether or not the language information of the first language setting is included in the settable language information. For example, when the first language setting information is received by the second communication controller 213 in response to the request for switching the language of the first language setting, the determining unit 216 obtains the settable language information stored in the storage unit 215 and determines whether or not the language information of the first language setting specified by the first language setting information is included in the settable language information. Specifically, the determining unit 216 determines whether or not the language of the first language setting which is set in the operation device 100 is settable in the image forming apparatus 200, too based on the settable language information of the image forming apparatus 200 so as to standardize the languages in the screen displays in the first display unit 111 of the operation device 100 and the second display unit 211 of the image forming apparatus 200.

The setting unit 217 sets and switches a language of a second language setting that indicates a language setting for the screen display of the second display unit 211. For example, when the language information of the first language setting is determined to be included in the settable language information by the determining unit 216, the setting unit 217 sets the language of the first language setting for the language of the second language setting that indicates the language setting for the screen display in the second display unit 211. On the other hand, when the language information of the first language setting is determined not to be included in the settable language information by the determining unit 216, the setting unit 217 sets the language of the second language setting as an alternative language which is different from the language of the first language setting. The alternative language set here may be preset language. The second display controller 212 thus controls the screen display in the second display unit 211 so that the screen is displayed with the set language depending on the language setting by the setting unit 217.

The alternative language may be selected by a user in each case. A case where the alternative language is selected by a user will be explained below. When the language information of the first language setting is determined not to be included in the settable language information, the screen generator 218 generates format information of a selection screen that allows selecting any one language of the settable language information as the alternative language. For example, when the language information of the first language setting is determined not to be included in the settable language information by the determining unit 216, the screen generator 218 obtains the settable language information from the storage unit 215 and generates the format information of the selection screen that allows selecting any one language of the settable language information as the alternative language. The second communication controller 213 thus performs the control of transmitting the format information of the selection screen generated by the screen generator 218 to the operation device 100 and the control of receiving the selected language information which is a result of the selection returned by the operation device 100 in response to the transmission of the format information of the selection screen.

When the selected language information is received by the second communication controller 213, the setting unit 217 sets the language of the second language setting as the language specified by the selected language information received by the second communication controller 213. The second display controller 212 thus controls the screen display in the second display unit 211 so that the screen is displayed with the set language (alternative language) depending on the language setting by the setting unit 217. As a result of this, the screen display with the language intended by a user is realized in the second display unit 211, too.

It is preferable that the switching of the language setting in the image forming apparatus 200 is performed depending on the operational status of the image forming apparatus 200. Specifically, the setting unit 217 switches the language of the second language setting if switching of the language setting is available depending on the operational status of the image forming apparatus 200 as the operation target apparatus. For example, in an interruption during an image processing such as printing, a facsimile processing, and the like when the operation target apparatus is the image forming apparatus 200, it is not preferable to switch the language of the second language setting as long as the language used currently is different from the language to switch. The setting unit 217 is therefore configured to switch the language of the second language setting when appropriate depending on the operational status of the image forming apparatus 200.

The second communication controller 213 performs a control of transmitting setting result information including a result of the language setting and the like to the operation device 100 via the communication unit 214. For example, the setting result information is information of the language set in the second language setting, information indicating that the language of the second language setting is set as requested by a user (setting OK), information indicating that the language of the second language setting is not set as requested by a user (setting NG), and the like. In the operation device 100, the setting result is displayed in the first display unit 111 depending on the reception of the setting result information and a processing for switching the language to be displayed in the screen of the first display unit 111 is performed.

Example of Screen of Operation Device

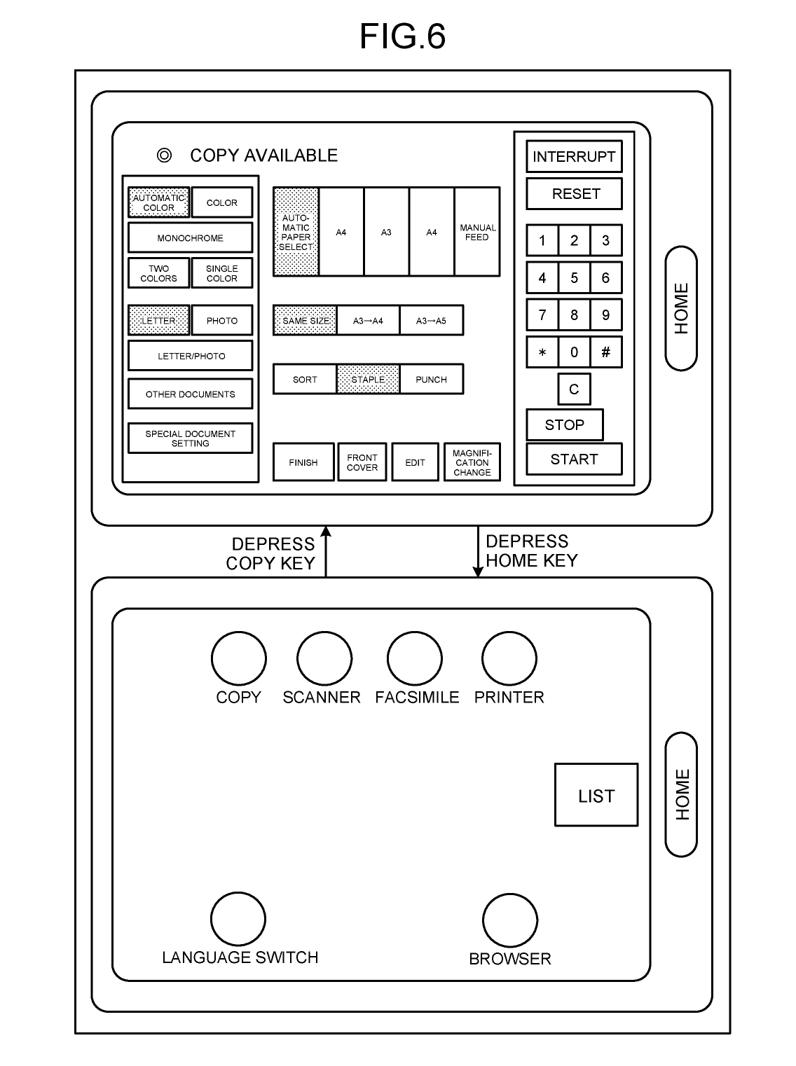

Next, a screen to be displayed in the first display unit 111 of the operation device 100 according to the first embodiment will be explained with reference to FIG. 6. FIG. 6 illustrates an example of a screen to be displayed in the first display unit 111 of the operation device 100 according to the first embodiment.

As illustrated in FIG. 6, a screen that allows operating the image forming apparatus 200 is displayed in the first display unit 111 of the operation device 100. For example, a home screen illustrated at a lower part of FIG. 6 is configured to be displayed in an initial condition and an operation screen illustrated at an upper part of FIG. 6 is configured to be displayed when a software key included in the home screen is depressed. In FIG. 6, a case where a copy key is depressed is taken as an example. There is an application that emulates a screen of the image forming apparatus 200 in the operation device 100 and an execution of this application enables emulating keys and the like present as hardware keys of the image forming apparatus 200 into a display by software keys. A user depresses a key for language switching to perform an operation for language setting when the user wants to switch the language to be displayed in the screen of the operation device 100.

Example of Selection Screen

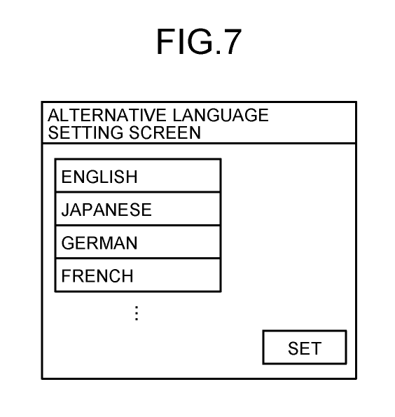

Next, the selection screen that allows selecting an alternative language according to the first embodiment will be explained with reference to FIG. 7. FIG. 7 illustrates an example of the selection screen that allows selecting an alternative language according to the first embodiment.

As illustrated in FIG. 7, the selection screen includes an item that allows selecting any one of multiple languages (languages specified by the settable language information) as an alternative language and a set key. A user performs an operation of selecting any one of the multiple languages and depresses the set key. Selected language information is thereby transmitted from the operation device 100 to the image forming apparatus 200 and language setting (alternative language setting) depending on the language specified by the selected language information is performed in the image forming apparatus 200.

Language Setting Processing Sequence According to First Embodiment

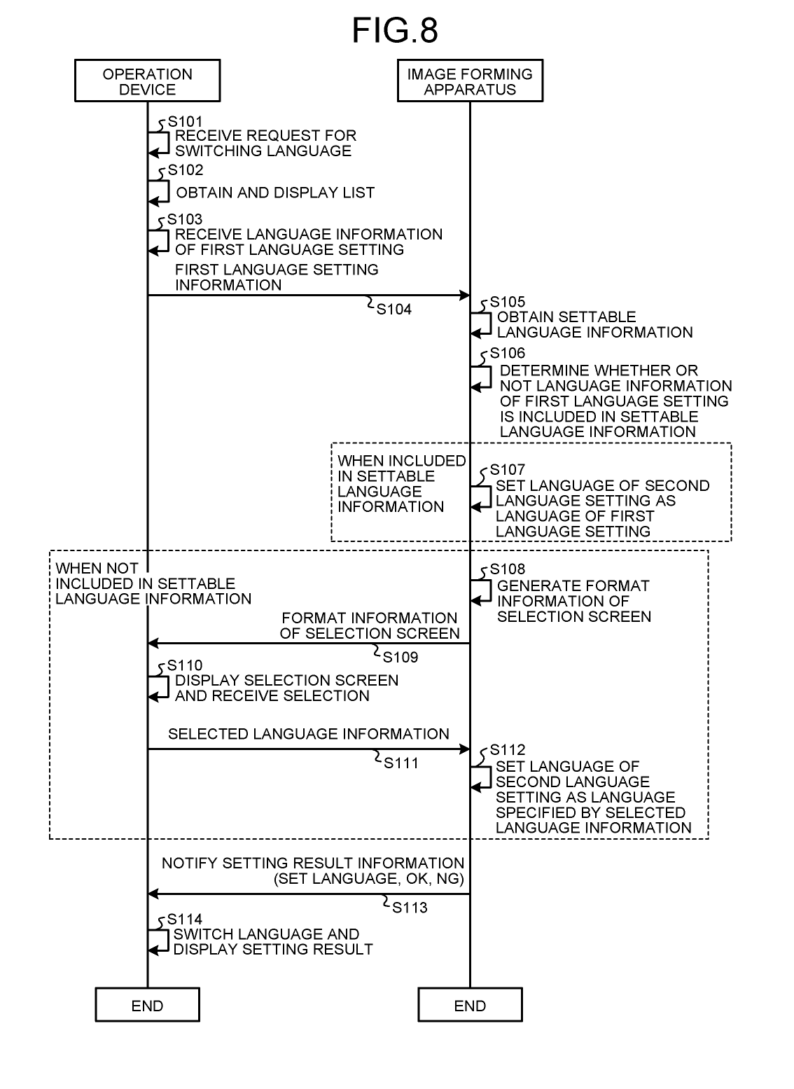

Next, a flow of a language setting processing according to the first embodiment will be explained with reference to FIG. 8. FIG. 8 is a sequence diagram of an example of a flow of a language setting processing according to the first embodiment. In FIG. 8, a case where a user is made to select an alternative language is also taken as an example and explained.

As illustrated in FIG. 8, the operation device 100 receives the request for switching the language in the screen display in the first display unit 111 (step S101). The operation device 100 obtains information of a language which is settable so that the screen is displayed with the language in the screen display in the first display unit 111 from the storage unit 113 and displays a list of languages settable in the first language setting (step S102). The operation device 100 then receives language information of the selected first language setting depending on the operation by the user (step S103). After that, the operation device 100 transmits the first language setting information including the received language information of the first language setting to the image forming apparatus 200 (step S104).

When receiving the first language setting information transmitted by the operation device 100, the image forming apparatus 200 obtains the settable language information from the storage unit 215 depending on the operational status, such as the image processing for printing, a facsimile processing, and the like, of the image forming apparatus 200 when it is not in the middle of these processing, i.e., when the switching of the language setting is available (step S105). The image forming apparatus 200 then determines whether or not the language information of the first language setting specified by the received first language setting information is included in the obtained settable language information (step S106). On this occasion, when the language information of the first language setting specified by the first language setting information is included in the obtained settable language information, the image forming apparatus 200 sets the language of the second language setting as the language of the first language setting (step S107). On the other hand, when the language information of the first language setting specified by the first language setting information is not included in the settable language information, the image forming apparatus 200 obtains the settable language information from the storage unit 215 and generates the format information of the selection screen that allows selecting any one language of the settable language information as an alternative language (step S108). The image forming apparatus 200 then transmits the generated format information of the selection screen to the operation device 100 (step S109).

When receiving the format information of the selection screen from the image forming apparatus 200, the operation device 100 displays the selection screen in the first display unit 111 and receives a selection depending on the operation by the user (step S110). The operation device 100 then transmits the selected language information as a result of the selection to the image forming apparatus 200 (step S111). When receiving the selected language information from the operation device 100, the image forming apparatus 200 sets the language of the second language setting as the language (alternative language) specified by the received selected language information (step S112). The image forming apparatus 200 then transmits the setting result information to the operation device 100 (step S113). The setting result information is information of the language of the second language setting, information indicating that the language is set as requested by the user (setting OK), and information indicating that the language of the second language setting is not set as requested by the user (setting NG). Specifically, the “setting OK” is returned when the language information of the first language setting specified by the first language setting is included in the settable language information or when the language setting depending on the selected language information is performed. The “setting NG” is returned when the language of the second language setting cannot be switched due to the operational status of the image forming apparatus 200. The operation device 100 thus receives the setting result information from the image forming apparatus 200, switches the language of the first language setting, and displays the setting result in the first display unit 111 (step S114).

### Advantages According to First Embodiment

Since the first language setting information is transmitted from the operation device 100 to the image forming apparatus 200 in response to the request, as a trigger, for switching the language of the first language setting and the language of the second language setting is switched to the language of the first language setting when the language information of the first language setting specified by the first language setting information is included in the settable language information of the image forming apparatus 200, it is possible in the information processing system 1 to control the settings of the languages to be displayed in both of the display units in conjunction with each other.

Besides, Since the format information of the selection screen that allows selecting any one language of the settable language information as an alternative language is generated when the language information of the first language setting specified by the first language setting information is not included in the settable language information and the language of the second language setting is switched to the language (alternative language) specified by the selected language information which is a result of the selection by the user, it is possible in the information processing system 1 to make the settings of the languages to be displayed in both of the display units satisfy the intention of the user.

Moreover, since the language of the second language setting is switched when the switching of the language setting is available depending on the operational status of the image forming apparatus 200 as the operation target apparatus, it is possible in the information processing system 1 to control the settings of the languages to be displayed in both of the display units without affecting the operation of the image forming apparatus 200.

### Second Embodiment

The language setting processing using a wired connection is explained in the first embodiment. A language setting processing using a wireless connection will be explained in a second embodiment.

Functional Configuration of Each Device According to Second Embodiment

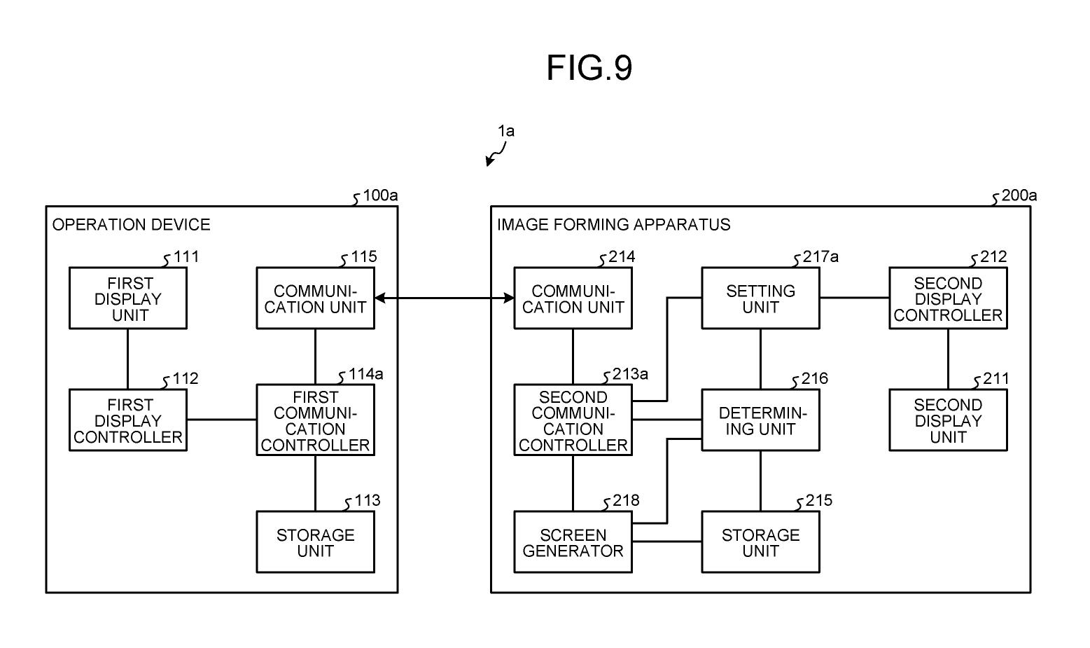

A functional configuration of each device according to a second embodiment will be explained with reference to FIG. 9. FIG. 9 is a block diagram of an example of a functional configuration of an operation device 100a and an image forming apparatus 200a according to the second embodiment. The same functional configuration of each device in the second embodiment will be assigned with the same reference symbol as the first embodiment and the detailed explanation thereof will sometimes be omitted.

As illustrated in FIG. 9, the operation device 100a is provided with the first display unit 111, the first display controller 112, the storage unit 113, a first communication controller 114a, and the communication unit 115. A part or all of the first display controller 112 and the first communication controller 114a may be realized by software (program) or may be realized by hardware circuit.

The first communication controller 114a performs a control of transmitting and receiving information of various kinds with the image forming apparatus 200a and the like via the communication unit 115. In this embodiment, a case where the communication unit 115 corresponds to the communication I/F 14 will be taken as an example. For example, the first communication controller 114a performs a control of transmitting, to the image forming apparatus 200a via the communication unit 115, the first language setting information when a wireless connection is established between the operation device 100a and the image forming apparatus 200a. As one mode, a trigger of transmitting the first language setting information is when a wireless connection is established between the operation device 100a and the image forming apparatus 200a. In other words, when recognizing via the communication unit 115 that the wireless connection between the operation device 100a and the image forming apparatus 200a is established, the first communication controller 114a performs a control of transmitting, to the image forming apparatus 200a via the communication unit 115, the first language setting information including the language information of the first language setting that is set at this point. To cite an instance, when a user carrying the operation device 100a such as a smartphone comes close to the image forming apparatus 200a, a wireless connection between the operation device 100a and the image forming apparatus 200a is established in response to a request for wireless connection by the operation device 100a and thereby the first language setting information is transmitted to the image forming apparatus 200a.

As illustrated in FIG. 9, the image forming apparatus 200a is provided with the second display unit 211, the second display controller 212, a second communication controller 213a, the communication unit 214, the storage unit 215, the determining unit 216, a setting unit 217a, and the screen generator 218. A part or all of the second display controller 212, the second communication controller 213a, the determining unit 216, the setting unit 217a, and the screen generator 218 may be realized by software (program) or may be realized by hardware circuit.

The second communication controller 213a checks a status of the wireless connection between the operation device 100a and the image forming apparatus 200a as the operation target apparatus. For example, when the wireless connection between the operation device 100a and the image forming apparatus 200a is established and the language setting is performed, the second communication controller 213a checks the status of the wireless connection with the operation device 100a. When the wireless connection between the operation device 100a and the image forming apparatus 200a is disconnected, the second communication controller 213a then notifies the setting unit 217a that the wireless connection is disconnected.

The setting unit 217a switches the language of the second language setting from the language of the current language setting to the language of the language setting set right before the current language setting or to the language of a preset language setting depending on the status of the wireless connection between the operation device 100a and the image forming apparatus 200a. For example, when the disconnection of the wireless connection between the operation device 100a and the image forming apparatus 200a is notified by the second communication controller 213a, the setting unit 217a switches the language of the second language setting from the language of the current language setting to the language of the language setting set right before the current language setting or to the language of a preset language setting. For the language of the language setting set right before the current language setting, there are two cases, i.e., the language of the language setting set right before the language of the second language setting is set as the language of the first language setting in one case and the language of the language setting set right before the language, selected by a user via the selection screen, of the selected language information is set in the other case. The language of the preset language setting may be an arbitrary language, however, is preferably the language of the language setting set by as many users as possible in the environment where the image forming apparatus 200a is used, for example, and it is thereby possible to reduce the number of executions of the language setting processing.

Language Setting Processing Sequence According to Second Embodiment

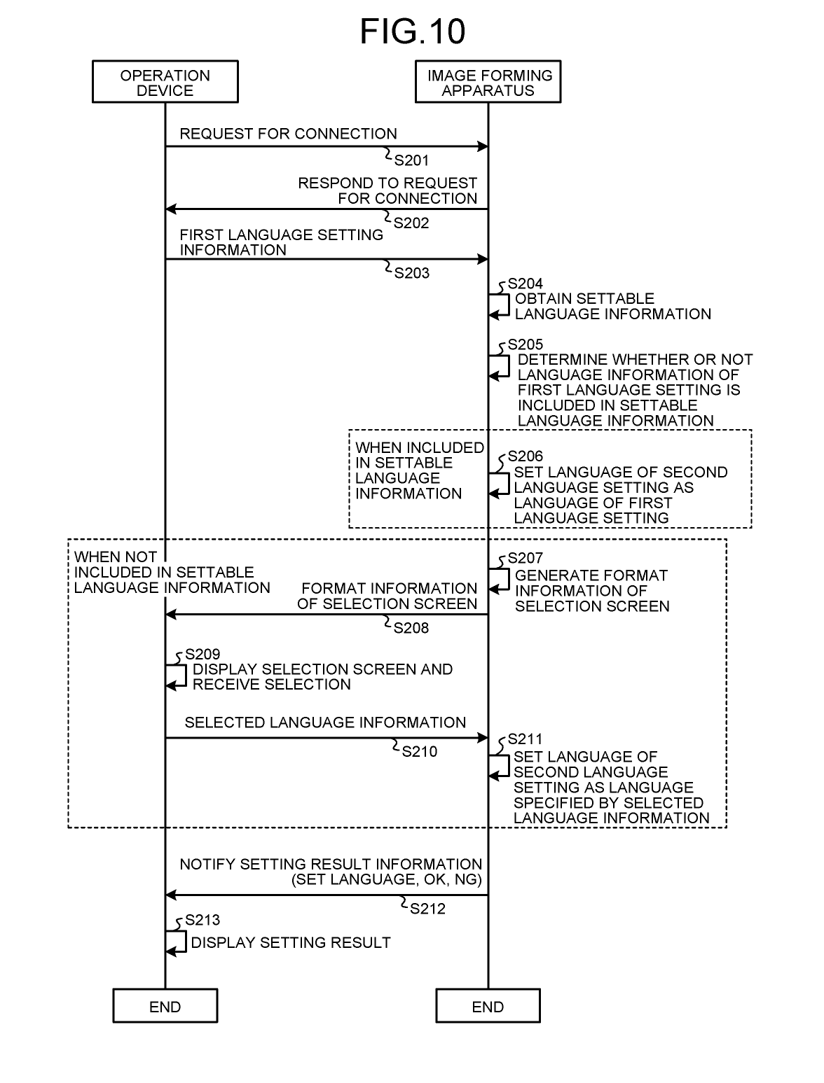

A flow of a language setting processing according to a second embodiment will be explained next with reference to FIG. 10. FIG. 10 is a sequence diagram of an example of a flow of a language setting processing according to the second embodiment.

As illustrated in FIG. 10, the operation device 100a makes a request for wireless connection to the image forming apparatus 200a (step S201). The image forming apparatus 200a responds to the request for wireless connection from the operation device 100a (step S202). Here, the wireless connection between the operation device 100a and the image forming apparatus 200a is established. The operation device 100a transmits the first language setting information to the image forming apparatus 200a in response to the establishment of the wireless connection with the image forming apparatus 200a (step S203).

When receiving the first language setting information transmitted by the operation device 100a, the image forming apparatus 200a obtains the settable language information the storage unit 215 depending on the operational status, such as the image processing for printing, a facsimile processing, and the like, of the image forming apparatus 200a when it is not in the middle of these processing, i.e., when the switching of the language setting is available (step S204). The image forming apparatus 200a then determines whether or not the language information of the first language setting specified by the received first language setting information is included in the obtained settable language information (step S205). On this occasion, when the language information of the first language setting specified by the first language setting information is included in the obtained settable language information, the image forming apparatus 200a sets the language of the second language setting as the language of the first language setting (step S206). On the other hand, when the language information of the first language setting specified by the first language setting information is not included in the settable language information, the image forming apparatus 200a obtains the settable language information from the storage unit 215 and generates format information of the selection screen that allows selecting any one language of the settable language information as an alternative language (step S207). The image forming apparatus 200a then transmits the generated format information of the selection screen to the operation device 100a (step S208).

When receiving the format information of the selection screen from the image forming apparatus 200a, the operation device 100a displays the selection screen in the first display unit 111 and receives a selection depending on an operation by a user (step S209). The operation device 100a then transmits the selected language information as a result of the selection to the image forming apparatus 200a (step S210). When receiving the selected language information from the operation device 100a, the image forming apparatus 200a sets the language of the second language setting as the language (alternative language) specified by the received selected language information (step S211). The image forming apparatus 200a then transmits the setting result information to the operation device 100a (step S212). The operation device 100a thus receives the setting result information from the image forming apparatus 200a and displays the setting result in the first display unit 111 (step S213). Since the request for switching the language of the first language setting in the operation device 100a is not used as a trigger in the present embodiment, no switching of the language of the first language setting in the operation device 100a arises in response to the language setting processing.

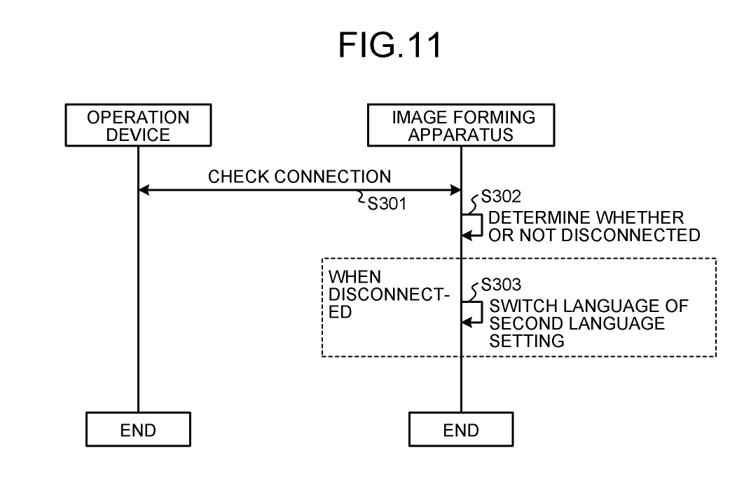

Language setting processing sequence in disconnection of wireless connection according to second embodiment Next, a flow of a language setting processing in disconnection of a wireless connection according to the second embodiment will be explained with reference to FIG. 11. FIG. 11 is a sequence diagram of an example of a flow of a language setting processing when a wireless connection is disconnected according to the second embodiment.

As illustrated in FIG. 11, the image forming apparatus 200a checks the status of the wireless connection with the operation device 100a (step S301) and determines whether or not the wireless connection with the operation device 100a is disconnected (step S302). When the wireless connection with the operation device 100a is disconnected, the image forming apparatus 200a switches the language of the second language setting from the language of the current language setting to the language of the language setting set right before the current language setting or to the language of a preset language setting (step S303).

### Advantages According to Second Embodiment

Since the first language setting information is transmitted from the operation device 100a to the image forming apparatus 200a in response to the establishment, as a trigger, of the wireless connection between the operation device 100a and the image forming apparatus 200a and the language of the second language setting is switched to the language of the first language setting when the language information of the first language setting specified by the first language setting information is included in the settable language information of the image forming apparatus 200a, it is possible in the image processing system 1a to control the settings of the languages to be displayed in both of the display units in conjunction with each other.

### Third Embodiment

While embodiments of the information processing system according to the present invention are explained so far, the invention may be implemented in various forms different from the above-explained embodiments. So, a different embodiment as for (1) Configuration and (2) Programs will be explained.

(1) Configuration

The processing procedure, the control procedure, the specific names, and information including data and parameters of various kinds explained in the specification and illustrated in the drawings may be arbitrarily changed unless otherwise specified. Each of constituents of the illustrated devices is conceptually illustrated in function and is not necessarily required to be configured physically as illustrated in the drawings. In other words, a specific form of disintegration and integration of each device is not limited to what is illustrated in the drawings and a part or all thereof may be disintegrated or integrated functionally or physically by an arbitrary unit depending on loads and usage conditions of various kinds.

(2) Programs

Programs to be executed in the operation device 100 and the image forming apparatus 200 according to an aspect of the present invention are provided by being recorded in a file of an installable format or of an executable format in a computer-readable recording medium such as a CD-ROM, a flexible disk (FD), a CD-R, and a DVD (Digital Versatile Disk) as a computer program product. The programs to be executed in the operation device 100 and the image forming apparatus 200 may be stored on a computer connected to a network such as the Internet and provided by being downloaded via the network. The programs to be executed in the operation device 100 and the image forming apparatus 200 may be provided or distributed via a network such as the Internet. The programs to be executed in the operation device 100 and the image forming apparatus 200 may be provided by being preloaded in a ROM and the like.

The programs to be executed in the operation device 100 have a module configuration including the units explained above (the first display controller 112 and the first communication controller 114) and, as an actual hardware, the units are configured to be loaded on a main storage device to generate on the main storage unit the first display controller 112 and the first communication controller 114 when the CPU reads out from a storage medium and execute the programs.

The programs to be executed in the image forming apparatus 200 have a module configuration including the units explained above (the second display controller 212, the second communication controller 213, the determining unit 216, the setting unit 217, and the screen generator 218) and, as an actual hardware, the units are configured to be loaded on a main storage device to generate on the main storage unit the second display controller 212, the second communication controller 213, the determining unit 216, the setting unit 217, and the screen generator 218 when the CPU reads out from a storage medium and execute the programs.

According to the embodiments, there is an advantage in that when an operation device and an operation target apparatus as an operation target of the operation device independently include respective display units, the settings of languages to be displayed in both of the display units can be controlled.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising:
an operation device; and
an operation target apparatus to be operated by the operation device,
the operation device including
a first display controller configured to control a screen display in a first display unit; and
a first communication controller configured to perform control of transmitting first language setting information to the operation target apparatus, the first language setting information including language information of a first language setting indicating a language setting for the screen display in the first display unit, and
the operation target apparatus including
a second display controller configured to control a screen display in a second display unit;
a second communication controller configured to perform control of receiving the first language setting information transmitted by the operation device;
a determining unit configured to determine whether the language information of the first language setting specified by the received first language setting information is included in settable language information indicating information of a language that is settable in the screen display in the second display unit; and
a setting unit configured to set, when the determining unit determines that the language information of the first language setting is included in the settable language information, a language of a second language setting indicating a language setting for the screen display in the second display unit, as a language of the first language setting.

2. The information processing system according to claim 1, wherein the setting unit sets the language of the second language setting as an alternative language different from the language of the first language setting when the determining unit determines that the language information of the first language setting is not included in the settable language information.

3. The information processing system according to claim 1, wherein
the operation target apparatus further includes a screen generator configured to generate format information of a selection screen for selecting any one language of the settable language information as an alternative language when the determining unit determines that the language information of the first language setting is not included in the settable language information,
the second communication controller performs control of transmitting the generated format information of the selection screen to the operation device,
the first communication controller performs control of receiving the format information of the selection screen transmitted by the operation target apparatus,
the first display controller performs control of displaying the selection screen in the first display unit based on the received format information of the selection screen and receiving a selection of any one language of the settable language information,
the first communication controller performs control of transmitting selected language information which is a result of the selection of the settable language information to the operation target apparatus,
the second communication controller performs control of receiving the selected language information transmitted by the operation device, and
the setting unit sets the language of the second language setting as a language specified by the received selected language information.

4. The information processing system according to claim 1, wherein the setting unit switches the language of the second language setting when switching of language setting is available depending on an operational status of the operation target apparatus.

5. The information processing system according to claim 1, wherein when a request for switching the language of the first language setting is received, the first communication controller performs control of transmitting the first language setting information including the language information of the first language setting after switching to the operation target apparatus.

6. The information processing system according to claim 1, wherein the first communication controller performs control of transmitting the first language setting information to the operation target apparatus when a wireless connection between the operation device and the operation target apparatus is established.

7. The information processing system according to claim 6, wherein
the second communication controller checks a status of the wireless connection between the operation device and the operation target apparatus, and
the setting unit switches the language of the second language setting from a language of a current language setting to one of a language of a language setting set right before the current language setting and a language of a preset language setting when the wireless connection between the operation device and the operation target apparatus is disconnected.

8. An operation target apparatus to be operated by an operation device including a first display unit, the operation target apparatus comprising:
a second display controller configured to control a screen display in a second display unit;
a second communication controller configured to perform control of receiving first language setting information transmitted by the operation device, the first language setting information including language information of a first language setting indicating a language setting for a screen display in the first display unit;
a determining unit configured to determine whether the language information of the first language setting specified by the received first language setting information is included in settable language information indicating information of a language that is settable in the screen display in the second display unit; and
a setting unit configured to set, when the determining unit determines that the language information of the first language setting is included in the settable language information, a language of a second language setting indicating a language setting for the screen display in the second display unit, as a language of the first language setting.

9. A non-transitory recording medium with an executable program stored thereon, wherein the program instructs a computer of an operation target apparatus to be operated by an operation device including a first display unit to perform:
controlling a screen display in a second display unit;
performing control of receiving first language setting information transmitted by the operation device, the first language setting information including language information of a first language setting indicating a language setting for a screen display in the first display unit;
determining whether the language information of the first language setting specified by the received first language setting information is included in settable language information indicating information of a language that is settable in the screen display in the second display unit; and
setting, when the language information of the first language setting is determined to be included in the settable language information, a language of a second language setting indicating a language setting for the screen display in the second display unit, as a language of the first language setting.
